(19) United States
(12) Patent Application Publication
(10) Pub. No.: US 2022/0165276 A1
(43) Pub. Date: May 26, 2022

(54) EVALUATION SYSTEM AND EVALUATION METHOD

(71) Applicant: HAKUHODO DY HOLDINGS INC., Tokyo (JP)

(72) Inventors: Koichiro YAMAOKA, Tokyo (JP); Ryo DOMOTO, Tokyo (JP); Ryoji MINAMI, Tokyo (JP); Ryoma YASUNAGA, Tokyo (JP); Jumpei IMURA, Tokyo (JP)

(21) Appl. No.: 17/442,470

(22) PCT Filed: Mar. 26, 2020
(86) PCT No.: PCT/JP2020/013642

§ 371 Date: Sep. 23, 2021

(30) Foreign Application Priority Data
Mar. 27, 2019 (JP) 2019-061311

(51) Int. Cl. G10L 17/22; G10L 21/028; G10L 17/06

(52) U.S. Cl. CPC G10L 17/22; G10L 17/06; G10L 21/028

(57) ABSTRACT

In an evaluation method according to one aspect of the present disclosure, an input voice signal is acquired from a microphone collecting voices in a business talk between a first speaker and a second speaker. A first voice component representing a voice of the first speaker and a second voice component representing a voice of the second speaker are separated in the input voice signal. In addition, a speech act of the first speaker is evaluated based on at least one of the first voice component and the second voice component.

### CROSS-REFERENCE TO RELATED APPLICATION

This international application claims the benefit of Japanese Patent Application No. 2019-61311 filed on Mar. 27, 2019 with the Japan Patent Office, and the entire disclosure of Japanese Patent Application No. 2019-61311 is incorporated herein by reference.

### TECHNICAL FIELD

The present disclosure relates to an evaluation system and an evaluation method.

### BACKGROUND ART

Systems to analyze and score a conversation between an operator in a call renter and a customer nave been known (see for example, Patent Document 1). In this system, voices in the conversation are obtained through headsets and/or telephones.

### PRIOR ART DOCUMENTS

### Patent Documents

Patent Document 1; Japanese Unexamined Patent Application Publication No. 2014-123813

### SUMMARY OF THE INVENTION

### Problems to be Solved by the Invention

However, the technique related to the aforementioned system cannot be used for the purpose of evaluating a face-to-face conversation that is not a conversation through a telephone. In a conversation between an operator and a customer through a telephone, a transmitted talk signal and a received talk signal independently exist. Thus, a voice signal of an individual speaker can be easily obtained, and the correspondence between the voce signal and the speaker is clear. On the other hand, in the face-to-face conversation, a mixed speech of speakers may be inputted into a microphone.

Thus, according to one aspect of the present disclosure, it is desirable to provide a technique for valuating a speech act of a target person from a mixed speech in a business talk.

### Means for Solving the Problems

An evaluation system according to one aspect of the present disclosure comprises an acquisition part, a separating part, and an evaluating part. The acquisition part is configured to acquire an input voice signal from a microphone collecting voices in a business talk between a first speaker and a second speaker. The separating part is configured to separate a first voice component and a second voice component in the input voice signal. The first voice component corresponds to a voice of the first speaker. The second voice component corresponds to a voice of the second speaker. The evaluating part is configured to evaluate a speech act of the first speaker based on at least one of the first voice component and the second voice component.

With this evaluation system, the speech act of the first speaker can be appropriately evaluated based on the input voice signal corresponding to the mixed speech obtained from the microphone during the business talk.

According to one aspect of the present disclosure, the evaluation system may comprise a storage part configured to store voice feature data representing a feature of a voice of a registered person. The first speaker may be the registered person. The second speaker may be a speaker other than the registered person. The separating part may separate the first voice component and the second voice component in the input voice signal based on the voice feature data.

In many cases, it is difficult to register the features of the voices of all the speakers participated in the business talk. In contrast, it is relatively easy to pre-register the feature of the voice of the first speaker who is the evaluation target. Thus, according to the method of separating the first voice component related to the registered person and the second voice component related to the non registered person in the input voice signal based on the voice feature data, the voice components necessary for the evaluation can be relatively easily obtained.

According, to one aspect of the present disclosure, the evaluating part may evaluate the speech act of the first speaker based on the second voice component, The second voice component may include the second speaker's reaction to the first speaker. Thus, the evaluation based on the second voice component achieves as evaluation based on the second speaker's reaction.

According to one aspect of the present disclosure, the evaluating part may evaluate the speech act of the first speaker based on a key word uttered from the second speaker and contained in the second voice component.

According to one aspect of the present disclosure, the evaluating part may extract a key word from the second voice component, the key word uttered from the second speaker and corresponding to a topic between the first speaker and the second speaker. The evaluating part may evaluate the speech act of the first speaker based on the key word extracted. This evaluation is useful to appropriately evaluate the speech act of the evaluation target speaker based on the reaction from the business partner.

According to one aspect of the present disclosure, the evaluating part may determine the topic based on the first voice component.

According to one aspect of the present disclosure, the evaluating part, may acquire identification info nation of a digital material displayed through a digital device from the first speaker to the second speaker. Based on the identification information, the evaluating part may extract a key word from the second voice component, the key word uttered from the second speaker and corresponding to the digital material. Based on the key word extracted, the evaluating part may evaluate the speech act of the first speaker.

In business talks, digital materials are often utilized. Appropriate speech acts are different depending on materials used. Thus, the evaluation based on the key word corresponding to the digital material is advantageous to more appropriately evaluate the speech act.

According to one aspect of the present disclosure, the evaluating part may evaluate the speech act of the first speaker based on at least one of a speaking speed, a voice volume, and a pitch of the second speaker. Based on the second voice component, the evaluating part may determine at least one of the speaking speed, the voice volume, and the pitch of the second speaker. The speaking speed, the voice volume, and the pitch of the second speaker vary depending on the emotions of the second speaker. Thus, the evaluation based on at least one of the speaking speed, the voice volume, and the pitch achieves an evaluation in consideration of the emotions.

According to one aspect of the present disclosure, the evaluating part may evaluate the speech act of the first speaker based on the first voice component. According to one aspect of the present disclosure, the evaluating part may evaluate the speech act of the first speaker based on a predetermined evaluation model.

According to one aspect of the present disclosure, the evaluating part may evaluate the speech act of the first speaker by use of an evaluation model among multiple evaluation models, the evaluation model corresponding to a topic between the first speaker and the second speaker. Optimal speech acts are different depending on topics. Thus, it is very advantageous to evaluate the speech act in accordance with the evaluation model corresponding to the topic.

According to one aspect of the present disclosure, the multiple evaluation models may be evaluation models calculating scores related to a speech act. The evaluating part may input feature data into an evaluation model among multiple evaluation models, the feature data related to the speech act of the first speaker based on the first voice component, the evaluation model corresponding to a topic between the first speaker and a second speaker. The evaluating part may evaluate the speech act of the first speaker based on a score outputted from the evaluation model corresponding to the topic in response to the feature data inputted.

According to one aspect of the present disclosure, the evaluating part may acquire identification information of a digital material displayed through a digital device from the first speaker to the second speaker, and based on the identification information, the evaluating part May evaluate the speech act of the first speaker by use of an evaluation model among multiple evaluation models, the evaluation model corresponding to the digital material displayed.

According to one aspect of the present disclosure, the evaluating part may select an evaluation model as a material-corresponding model among multiple evaluation models, the evaluation model corresponding to the digital material displayed, the multiple evaluation models calculating scores related to a speech act, and the evaluating part may input feature data into the material-corresponding model, the feature data related to the speech act of the first speaker based on the first voice component. The evaluating part may evaluate the speech act of the first speaker based on a score outputted from the material-corresponding model in response to the feature data inputted.

According to one aspect of the present disclosure, the evaluating part may determine distribution of utterance of the first speaker and the second speaker based on the input voice signal. Based on the distribution, the evaluating part may evaluate the speech act of the first speaker. As the distribution, the evaluating part may determine at least one of a ratio of utterance time between the first speaker and the second speaker and a ratio of an amount of utterance between the first speaker and the second speaker.

In many cases, one-sided conversation from the first speaker is caused by the second speakers lack of interest. If the second speaker is interested in what the first speaker talks, the second speaker is more likely to talk to the first speaker. Thus, the evaluation of the speech act based on the above-described ratios achieves an appropriate evaluation of the speech act of the first speaker.

According to one aspect of the present disclosure, the evaluating part may estimate a problem that the second speaker has based on the second voice component. The evaluating part may determine whether the first speaker provides the second speaker with information corresponding to the problem based on the first voice component. The evaluating part may evaluate the speech act of the first speaker based on the determination whether the information is provided.

According to one aspect of the present disclosure, based on the first voice component and the second voice component, the evaluating part may determine whether the first speaker develops a talk for the second speaker in accordance with a predetermined scenario, the talk corresponding to a reaction of the second speaker. The evaluating part may evaluate the speech act of the first speaker based on the determination whether the talk is developed.

According to one aspect of the present disclosure, a computer-implemented evaluation method may be provided. The evaluation method may comprise: acquiring an input voice signal from a microphone collecting voices in a business talk between the first speaker and the second speaker; separating a first voice component representing a voice of the first speaker and a second voice component representing a voice of the second speaker in the input voice signal; and evaluating a speech act of the first speaker based on at least one of the first voice component and the second voice component separated. The evaluation method may include processes similar to the processes performed in the aforementioned evaluation system.

According to one aspect of the present disclosure, a computer program to make a computer function as the acquisition part, the separating part, and the evaluating part in the aforementioned evaluation system may be provided. A computer program including instructions to make a computer perform the aforementioned evaluation method may be provided. A computer readable non-transitory storage medium storing the computer program may be provided.

### BRIEF DESCRIPTION OF THE DRAWINGS

FIG. 1 is a diagram showing a configuration of an evaluation system.

FIG. 2 is a flowchart showing a record transmission process that a processor in a mobile device performs.

FIG. 3 is a diagram showing a configuration of business talk recorded data.

FIG. 4 is a flowchart showing an evaluation output process performed by a processor in a server device.

FIG. 5 is a diagram showing configurations of various data stored in the server device.

FIG. 6 is an explanatory diagram related to speaker identification and topic determination.

FIG. 7 is a flowchart showing a topic determination process performed by the processor.

FIG. 8 is a flowchart showing a first evaluation process performed by the processor.

FIG. 9 is a flowchart showing a second evaluation process performed by the processor.

### EXPLANATION OF REFERENCE NUMERALS

1 . . . evaluation system, 10 . . . mobile device, 11 . . . processor, 12 . . . memory, 13 . . . storage, 15 . . . microphone, 16 . . . manipulation device, 17 . . . display 19 . . . communication interface, 30 . . . server device, 31 . . . processor, 32 . . . memory, 33 . . . storage, 39 . . . communication interface, 50 . . . management device, D1 . . . business talk recorded data, D2 . . . voice data, D3 . . . display history data, D31 . . . target person database, D32 . . . material-related database, D33 . . . topic key word database, D34 . . . first evaluation criteria database, D35 . . . second evaluation criteria database

### MODE FOR CARRYING OUT THE INVENTION

Hereinafter, example embodiments of the present disclosure will be described with reference to the drawings.

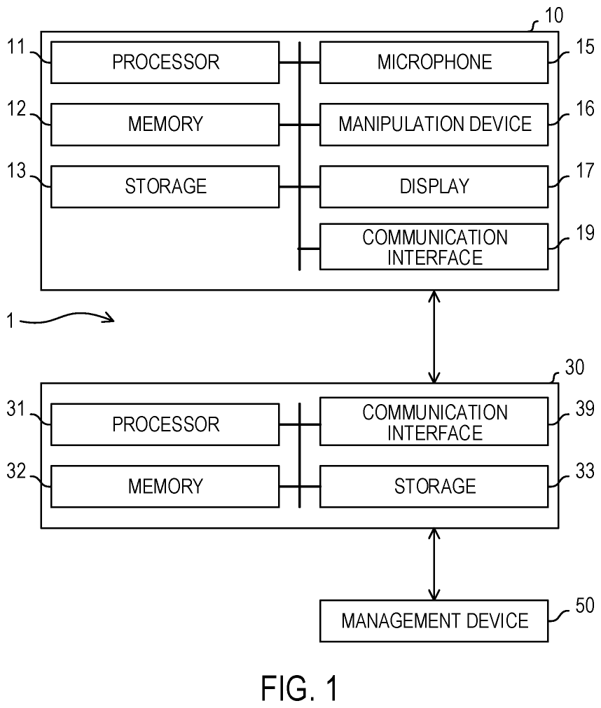

An evaluation system 1 of the present embodiment shown in FIG. 1 is a system to evaluate a business talk act made by a target person for a business partner. The evaluation system 1 is configured to evaluate, as the business talk act, a speech act of the target person in a business talk.

The target person may be, for example, an employee of a company that wishes to obtain evaluation information on the business talk acts made by employees. The evaluation system 1 functions especially effectively in a case where the business talk is made between two of the target person and the business partner. Examples of the business talk may include a business talk on medicines between an employee of a pharmaceutical products manufacturing company and a doctor.

The evaluation system 1 comprises, as shown in FIG. 1, a mobile device 10, a server device 30, and a management device 50. The mobile deice 10 is brought by the target person into a space where the business talk is made. The mobile device 10 is configured of, for example, a well-known mobile computer having a dedicated computer program installed.

The mobile device 10 is configured to record voices during the business talk, and moreover, the mobile device 10 is configured to record a display history of a digital material shown to the business partner. The mobile device 10 is configured to transmit voice data D2 and display history data D3 generated by these recording operations to the server device 30.

The server device 30 is configured to evaluate the business talk act of the target person based on the voice data D2 and the display history data D3 received from the mobile device 10. The evaluation information is provided to the management device 50 of a company that uses an evaluation service offered by the server device 30.

The mobile device 10 comprises a processor 11, a memory 12, a storage 13, a microphone 15, a manipulation device 16, a display 17, and a communication interface 19.

The processor 11 is configured to perform a process in accordance with a computer program stored in the storage 13. The memory 12 includes a RAM and al ROM. The storage 13 stores not only the computer program, but also various data provided to processes by the processor 11.

The microphone 15 is configured to collect voices uttered in a space surrounding the mobile device 10 and is configured to input the voices into the processor 11 as an electrical voice signal. The manipulation device 16 comprises a key-board, a pointing device and the like, and is configured to input an operation signal from the target person into the processor 11.

The display 17 is configured to display various information under the control of the processor 11. The communication interface 19 is configured to communicate with the server device 30 through a wide area network.

The server device 30 comprises a processor 31, a memory 32, a storage 33, and a communication interface 39. The processor 31 is configured to perform a process in accordance with a computer program stored in the storage 33. The memory 32 includes a RAM and a ROM. The storage 33 stores the computer program and various data provided to processes by the processor 31. The communication interface 39 is configured to communicate with the mobile device 10 and the management device 50 through the wide area network.

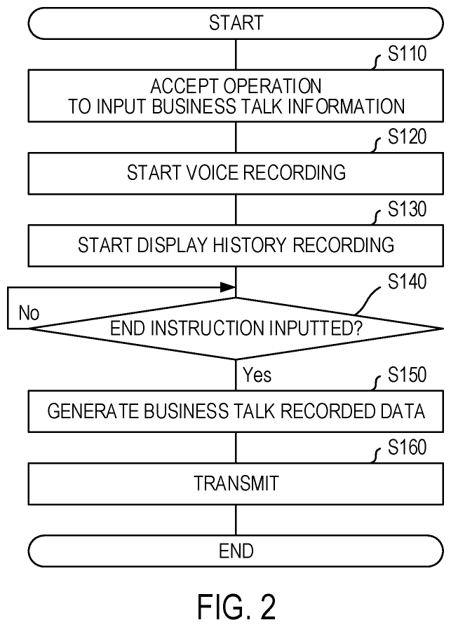

Next, a record transmission process performed by the processor 11 of the mobile device 10 will be described with reference to FIG. 2. At the beginning of the business talk, in response that art instruction to execute a corresponding computer program is inputted from the target person through the manipulation device 16, the processor 11 starts the record transmission process shown in FIG. 2.

Upon starting the record transmission process, the processor 11 accepts an operation to input business talk information through the manipulation device 16 (S110). The business talk information includes information that can identify a place of the business talk and a person to have the business talk with.

Upon completion of the operation to input the business talk information, the processor 11 proceeds to S120 and starts a voice recording process. In the voice recording process, the processor 11 operates to store the voice data D2 corresponding to the input voice signal from the microphone 15 in the storage 13.

The processor 11 further proceeds to S130 and starts a recording process of the display history of the digital material. The recording process of the display history is performed concurrently with the voice recording process started in S120. In this recording process of the display history, the processor 11 monitors the operation of the task of displaying the digital material on the display 17, thereby storing, in the storage 13, a record representing a material ID and a display period of each digital material displayed on the display 17. Here, the material ID is identification information of the corresponding digital material.

In the present embodiment, a digital material on each page in a single data file may be handled as a separate digital material. In this case, a distinct material ID is assigned to the digital material on each page in the same data file.

The processor 11 performs the voice recording process and the recording process of the display history until an end instruction is inputted from the target person through the manipulation device 16 (S140). In response to the end instruction inputted, the processor 11 generates business talk recorded data D1 including the contents of recordings obtained in these processes (S150). The processor 11 transmits the generated business talk recorded data D1 to the server device 30 (S160). Then, the processor 11 ends the record transmission process.

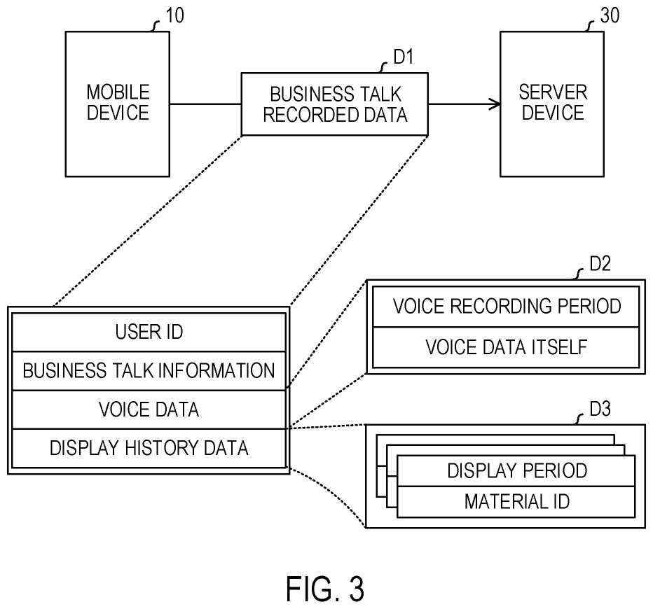

FIG. 3 shows details of the business talk recorded data D1. The business talk recorded data D1 includes a user ID, business talk, information, the voice data D2, and the display history data D3. The user ID is identification information on the target person who uses the mobile device 10. The business talk information corresponds to the information inputted from the target person in S110.

The voice data D2 comprises the voice data itself recorded in the voice recording process and information on a voice recording period. The information on the voice recording period is information indicating, for example, a recording start date and time and a recording time. The display history data D3 includes a record representing the material ID and display period of each digital material displayed during the voice recording.

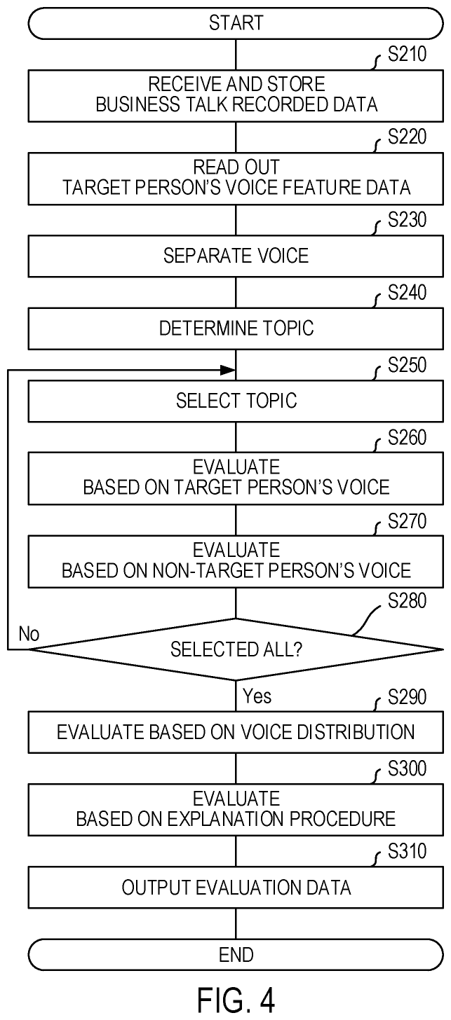

Then, details of an evaluation output process performed by the processor 31 of the server device 30 will be described with reference to FIG. 4. In response to access from the mobile device 10, the processor 31 starts the evaluation output process.

Upon starting the evaluation output process, the processor 31 receives the business talk recorded data D1 from the mobile device 10 through the communication interface 39 (S210). Based on the user ID contained in the business talk recorded data D1, the processor 31 further reads out the target person's voice feature data associated with the user ID from the storage 33 (S220).

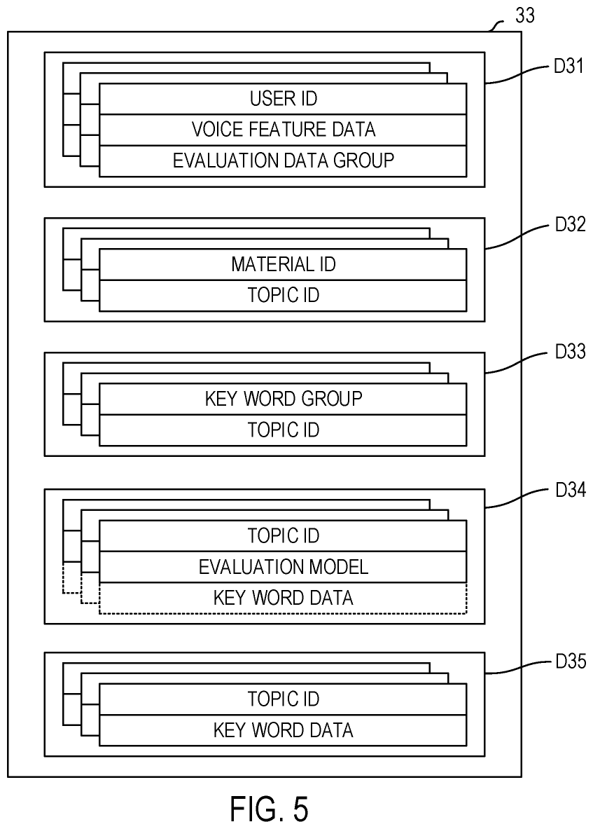

As shown in FIG. 5, the storage 33 stores a target person database D31 containing the voice feature data and evaluation data group of the target person for each user ID. The voice feature data indicates feature of a voice acquired in advance from the target person corresponding to the associated user ID.

The voice feature data is used to identify the target person's voice contained in the voice data D2 in the business talk recorded data D1. Thus, the voice feature data con indicate a voice feature amount used for speaker identification.

The voice feature data may be parameters for an identification model that is machine learned to identify whether each voice contained in the voice data D2 is the voice of the target person corresponding to the user ID. For example, the identification model is built by machine learning using, as teacher data, the target person's voice when the target person reads a phoneme balanced sentence having a phoneme pattern arranged in a good balance. For the machine learning, neural network, deep learning, and support vector machine may be used. The identification model can be configured to output a value representing whether a speaker of the inputted data is the target person, or the probability that the speaker of the inputted data is the target person.

The evaluation data group includes evaluation data representing the results of evaluation Of the business talk act made by the target person in each business talk. The evaluation data is generated by the processor 31 every time the business talk recorded data DI is received (this will be described in detail below).

In the following S230, the processor 31 analyzes the voice data D2 contained in the business talk recorded data D1 received, and separates the voice signal contained in the voice data D2 into a voice component of the target person and a voice component of a non-target person (S230).

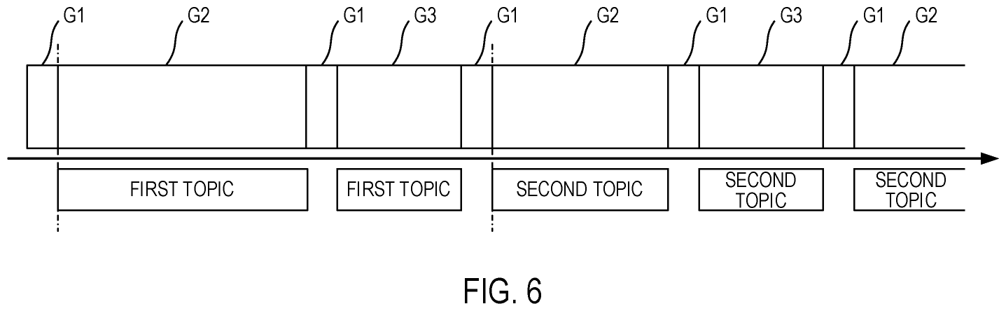

For example, as shown in FIG. 6, the processor 31 divides the voice recording period into utterance sections each containing a human voice and non-utterance sections G1 each not containing the human voice. In addition, the processor 31 classifies the utterance sections into target person sections G2 that are the target person's utterance sections, and non-target person sections G3 that are the non-target person's utterance sections. With this classification, the voice contained in the voice data D2 are separated into the target person's voice sections and the non-target person s voice sections.

The processor 31 can identify a speaker in each utterance section based on a part of the voice data corresponding to the utterance section and the target person's voice feature data read out in S220.

For example, the processor 31 may input the part of the voice data corresponding to the utterance section into the above-described identification model that is based on the voice feature data. From the identification model, the processor 31 may obtain a value representing whether the speaker of the part of the voice data is the target person.

Alternatively, the processor 31 may analyze the part of the voice data corresponding to the utterance section and extract a voice feature amount. Then, the processor 31 may compare the extracted voice feature amount with the voice feature amount of the target person, and determine whether the speaker is the target person or the non-target person.

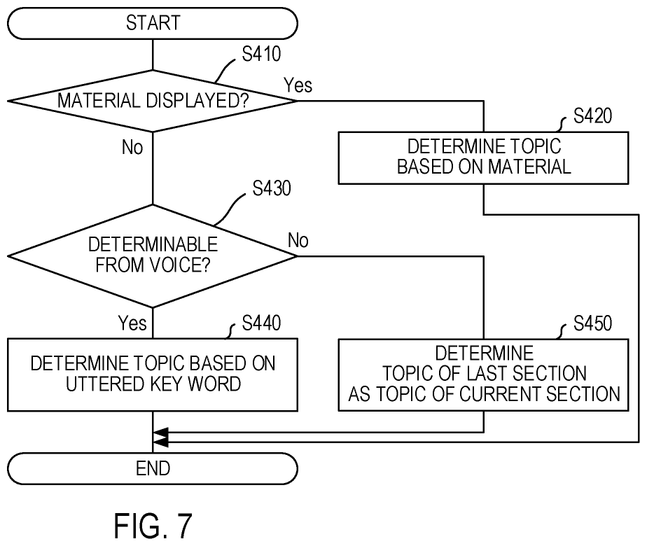

After the process is performed in S230, as shown in FIG. 6, the processor 31 determines a topic of each utterance section (S240). In S240, the processor 31 can perform a process shown in FIG. 7 for each utterance section.

In the process shown in FIG. 7, the processor 31 determines whether any digital material is displayed in the corresponding utterance section (S410). The processor 31 may refer to the display history data D3 contained in the business talk recorded data D1 and determine whether any digital material is displayed during the time overlapping with the corresponding utterance section.

The start time and end time of the corresponding utterance section can be determined based on the information on the voice recording period contained in the voice data D2 and a position of the utterance section in the voice data D2. In a case where the percentage of time that the digital material is displayed in the corresponding utterance section is less than a specified percentage, the processor 31 may determine that no digital material is displayed in the corresponding utterance section.

If the processor 31 determines that the digital material is displayed (Yes in S410), the processor 31 determines a topic of the corresponding utterance section based on the digital material displayed (S420). The processor 31 can refer to a material-related database D32 stored in the storage 33, and determine the topic corresponding to the digital material displayed.

The material-related database D32 indicates a correspondence between a digital material and a topic for each digital material. For example, as shown in FIG. 5, the material-related database D32 is configured to stoic a topic ID, which is identification information of a topic, in association with the material ID for each digital material.

In a case where a digital material displayed is changed to another digital material during the corresponding utterance section, the processor 31 may determine a topic corresponding to the digital material displayed longer as the topic of the corresponding utterance section (S420).

On the other hand, if the processor 31 determines that no digital material is displayed (No in S410), the processor 31 determines whether the topic can be determined from the voice in the corresponding utterance section (S430).

If the processor 31 determines that the topic can be determined from the voice in the corresponding utterance section (Yes in S430), the processor 31 determines the topic of the corresponding utterance section based on a key word contained in the voice in the corresponding utterance section (S440). It is noted that the term “key word” used herein should be interpreted in a broad meaning even including a key phrase composed of a combination of words.

In S440, the processor 31 refers to a topic key word database D33 stored in the storage 33, and searches through the voice in the corresponding utterance section for a key word registered in the topic key word database D33. Then, the processor 31 compares a key word group in the utterance section found through the search with a registered key word group for each topic, and determines the topic of the corresponding utterance section.

The processor 31 can search for the: key word based on text data generated by conversion of voice to text. The conversion of voice to text can be performed in S440 or S230. In another example, the processor 31 may detect a phoneme sequence pattern corresponding to the key word from a voice waveform represented by the voice data D2, thereby detecting the key word contained in the voice in the corresponding utterance section.

The topic key word database D33 is configured to store, for example, a topic-related key word group (i.e. the registered key word group) in association with the topic ID for each topic. In this case, the processor 31 determines that a topic associated with the registered keyword group having the highest match rate with the keyword group of the utterance section is the topic of the utterance section.

Alternatively, by use of conditional probability of the combination of the key words, the processor 31 can determine the most probable topic in a statistical viewpoint as the topic of the corresponding utterance section.

If the processor 31 makes negative determination in S430, the processor 31 proceeds to S450 and determines that the topic of the corresponding utterance section is the same as the topic of the utterance section one before the corresponding utterance section.

The process in S430 will be described in detail. In a case where the topic can be determined with high accuracy in the process of S440, the processor 31 determines that the topic can be determined from the voice (Yes in S430), Otherwise, the processor 31 may make the negative determination (No in S430).

For example, in a case where the number of phonemes uttered or the number of key words that can be extracted from the corresponding utterance section are specified values or more, the processor 31 can make the positive determination in S430. In a case where the numbers are less than the specified values, the processor 31 can make the negative determination in S430.

In S240, the processor 31 can determine the topic of each of the target person sections G2 and the non-target person sections G3 by the process shown in FIG. 7. In another example, the processor 31 may determine the topic of each target person section G2 by the process shown in FIG. 7, and determine the topic of each non-target person section G3 to be the same as the topic of the utterance section before the corresponding non-target person section G3. That is, when determining the topic of each non-target person section G3, the processor 31 may perform only the process of S450. In this case, the processor 31 determines the topic of each utterance section in the voice recording period not from the utterance of the non-target person, but from the utterance of the target person.

After determining the topic of each section in S240, the processor 31 selects one of the topics contained, in the voice data D2 as a process target topic in the following S250. Then, the processor 31 evaluates the business talk act of the target person related to the process target topic from multiple aspects (S260-S270).

Specifically, in S260, the processor 31 evaluates the business talk act of the target person based on the target person's voice in the target person sections G2 corresponding to the process target topic, i.e., in the utterance sections in which the target person speaks in relation to the process target topic. In S270, the processor 31 evaluates the business talk act of the target person based on the non-target person's voice in the non-target person sections G3 corresponding to the process target topic, i.e., in the utterance sections in which the non-target person speaks in relation to the process target topic.

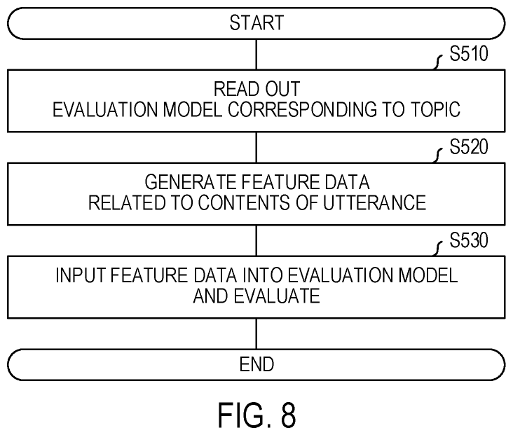

In S260, the processor 31 can perform a first evaluation process shown in FIG. 8. In FIG. 8, the processor 31 refers to a first evaluation criteria database D34 and reads out an evaluation model corresponding to the process target topic (S510).

The storage 33 stores the first evaluation criteria database D34 containing information to evaluate the business talk act of the target person based on the target person's voice. The first evaluation criteria database D34 stores an evaluation model associated with the corresponding topic ID for each topic.

The evaluation model corresponds to a mathematical model to score the speech act of the target person based on a feature vector related to the contents of utterance in an evaluation target section. This evaluation model can be built by machine learning by use of a group of teacher data. Examples of the evaluation model based on the machine learning may include a regression model, a neural network model, and a deep learning model. Each of the teacher data is a data set comprising: the feature vector corresponding to input data to the evaluation model; and a score. The group of teacher data may include data sets each comprising: a feature vector based on an exemplary speech act in accordance with a talk script; and a corresponding score (for example, perfect score of 100 points).

The feature vector may be a vector representation of the whole contents of utterance in the evaluation target section. For example, the feature vector may be formed by morphologically analyzing the whole contents of utterance of the evaluation target section, and quantifying morphemes individually and arraying the quantified morphemes.

In another example, the feature vector may be an array of the key wards extracted from the contents of utterance in the evaluation target section. The array may be an array of the key words arranged in the order of utterances. In this case, as indicated with a broken line frame in FIG. 5, key word data for each topic may be stored in the first evaluation criteria database D34. That is, the first evaluation criteria database D34 may be configured to include, association with the evaluation model for each topic, the key word data defining a group of key words to be extracted at the time of generating the feature vector.

In the following S520, based oil the contents of utterance of the target person sections G2 corresponding to the process target topic, the processor 31 generates a feature vector related to the contents of utterance of the target person in these target person sections G2 as input data to the evaluation model. In a case where there are multiple target person sections G2 corresponding to the process target topic, the processor 31 can collect the contents of the utterances of these sections and generate the feature vector.

In S520, the processor 31 can morphologically analyze the contents of utterance of the target person sections G2 corresponding to the process target topic and generate the aforementioned feature vector. Alternatively, the processor 31 may search and extract the group of key words registered in the key word data from the contents of utterance of the target person sections G2 corresponding to the process target topic and array the extracted key words to generate the feature vector.

In the following S530, the processor 31 inputs the feature vector generated in S520 into the evaluation model read out in S510, and obtains a score on the speech act of the target person regarding the process target topic from the evaluation model. That is, by use of the evaluation model, the score corresponding to the feature vector is calculated. This score obtained here is referred to as a first score. The first score is an evaluation value concerning the business talk act of the target person based on the evaluation of the target person's voice.

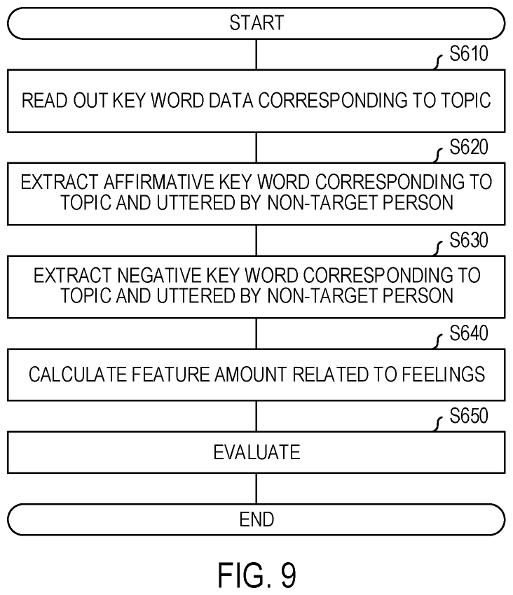

In this way, in S260, the processor 31 evaluates the business talk act of the target person based on the target person's voice. In the following S270, the processor 31 evaluates the business talk act of the target person based on the non-target person's voice in the non-target person sections G3 corresponding to the process target topic by performing the second evaluation process shown in FIG. 9.

In the second evaluation process, the processor 31 refers to the second evaluation criteria database D35 and reads out key word data corresponding to the process target topic (S610). The storage 33 stores the second evaluation criteria database D35 containing information to evaluate the business talk act of the target person based on the non-target person's voice.

The second evaluation criteria database D35 stores key word data in association with the corresponding topic ID for each topic. The key word data comprises a key word group affirmative to the business talk act of the target person and a key word group negative to the business talk act of the target person. These key word groups comprise key words uttered by the non-target person in response to the explanation of products and/or services by the target person.

In the following S620, from the contents of utterance of the non-target person sections G3 corresponding to the process target topic, the processor 31 searches and extracts the affirmative key word group registered in the key word data read out in S610. In the following S630, from the contents of utterance of the above-described non-target person sections G3, the processor 31 searches and extracts the negative key word group registered in the read-out key word data.

In addition, the processor 31 analyzes the non-target person's voice in the same sections, and calculates a feature amount related to the non-target person's feelings. For example, as the feature amount related to the feelings, the processor 31 can calculate at least one of the speaking speed, voice volume, and pitch of the non-target person (S640). The feature amount related to the feelings may include an amount of change in at least one of the speaking speed, the voice volume, and the pitch.

Then, based on the information acquired in S620-S640, the processor 31 calculates a score on the business talk act of the target person regarding the process target topic in accordance with a specified evaluation formula or an evaluation rule (S650). With this score calculation, the business talk act of the target person is evaluated from the non-target person's voice (S650). Hereinafter, the score calculated here will be referred to as a second score. The second score is an evaluation value of the business talk act of the target person based on the evaluation of the reaction obtained from the non-target person's voice.

According to a simple example, in S650, the second score can be calculated by adding a point to a standard point in accordance with the number of the affirmative key words, and by reducing a point from the standard point in accordance with the number of the negative key words. Moreover, the second score is corrected in accordance with the feature amount related to the feelings. In a case where the feature amount related to the feelings shows the non-target person's negative feelings, the second score may be corrected to reduce a point. For example, in a case where the speaking speed is higher than a threshold value, the second score may be correct to reduce a specified amount of points.

After calculating the first score and the second score relative to the process target topic as described above (S260, S270), the processor 31 determines whether all of the topics contained in the voice data D2 is selected as the process target topic and the first score and the second score are calculated (S280).

In a case where there is a topic that is not selected as the process target topic, the processor 31 makes negative determination in S280 and moves to S250. Then, the processor 31 selects the unselected topic as a new process target topic, and calculates the first score and the second score with respect to the selected process target topic (S260, S270).

In this way, the processor 31 calculates the first score and the second score for each topic contained in the voice data D2. In a case where all of the topics are selected as the process target topics and the first scores and the second scores are calculated, the processor 31 makes positive determination in S280 and proceeds to S290.

In S290, the processor 31 evaluates the business talk act of the target person based on a voice distribution during the voice recording period. The processor 31 may calculates a third score, as an evaluation value related to a voice distribution, based on a conversational ball rolling rate.

The conversational ball rolling rate may be, for example, a ratio of an amount of utterance, specifically a ratio of the number of phonemes uttered. The ratio of the number of phonemes uttered may be calculated by a ratio of N2/N1, wherein N1 is the number of phonemes uttered by the target person in the voice recording period and N2 is the number of phonemes uttered by the non-target person.

In another example, the conversational ball rolling rate may be a ratio of utterance time. The ratio of the utterance time may be calculated by a ratio of T2/T1, wherein T1 is a target person's utterance time that is the sum of the time lengths of the target person sections G2 in the voice recording period, and T2 is a non-target person's utterance time that is the sum of the time lengths of the non-target person sections G3 in the voice recording period.

The processor 31 can calculate the third score according to a specified evaluation rule to increase the score as the ratio of the number of phonemes uttered or the ratio of utterance time is higher. When these ratios are higher, it means that the non-target person positively responds to the target person's speech act.

The processor 31 may be configured to calculate the third score based on not only the above-described ratios, but also a rhythm of utterance turns between the target person and the business partner. The processor 31 may calculate the third score so that the third score is increased when the turns are taken at appropriate time intervals, and otherwise, the third score is reduced.

In S300 following S290, the processor 31 evaluates, the business talk act of the target person based on a flow of explanation made by the target person in the voice recording period, and calculates a fourth score as a corresponding evaluation value.

As a first example, the processor 31 may calculate the fourth score based on, for example, whether the order of topics in the voice recording period is appropriate, and whether explanations related to the topics suitable for each time section (an early stage, a middle stage and a final stage) are made in the voice recording period.

As a second example, the processor 31 may identify a display order of the digital materials and calculate the fourth score based on the display order of the digital materials. In this case, the fourth score is calculated to a lower value as the display order of the materials deviates from an exemplary display order.

As a third example, the processor 31 may estimate, based on the contents of utterance of the non-target person in each non-target person section G3, a problem that the non-target person has for each non-target person section G3. For this estimation, the storage 33 may pre-store a database indicating a correspondence between the key word uttered by the non-target person and a problem that the non-target person has. The processor 31 can refer to this database and estimate the problem that the non-target person has based on the contents of utterance of the non-target person, or more specifically, based on the key words uttered by the non-target person.

In the third example, the processor 31 may farther determine whether the target person provides the non-target person with information corresponding to the estimated problem, based on the contents of utterance of the target person section G2 that follows the non-target person section G3. For this determination, the storage 33 can pre-store a database indicating a correspondence between each problem and information related to a solution to be provided to the non-target person having the problem. The processor 31 can refer to this database and determine whether the target person provides the non-target person with the information corresponding to the estimated problem.

In the third example, the processor 31 can further calculate the fourth score based on whether the target person provides the non-target person with the information corresponding to the problem. For example, the processor 31 can calculate a value, as the fourth score, in accordance with the proportion that the target person properly provides the non-target person with the information that should be provided.

As a fourth example, the processor 31 may determine a reaction type of the non-target person in each non-target person section G3 based on the contents of utterance of the non-target person in each non-target person section G3. The processor 31 may further determine, based on the contents of utterance of the target person section G2 that follows the non-target person section G3, whether the target person develops a talk for the non-target person in accordance with a predetermined scenario, the talk corresponding to the non-target person's reaction.

For this determination, the storage 33 may pre-store a scenario database for each topic, the scenario database defining a talk that should be developed for the non-target person for each reaction type of the non-target person. The processor 31 can refer to this scenario database and determine whether the target person develops the talk corresponds to the non-target person's reaction for the non-target person. Based on this determination result, the processor 31 can calculate, as the fourth score a score based on a match rate with the scenario.

Example of development of business talk may include: (1) providing a customer with several topics in order to find a customer's problem, (2) estimating the customer's problem from the customer's reaction to the topics, (3) providing information leading to a solution for the estimated problem, and (4) appealing that the company to which products or the target person belongs contributes to solve the problem. The use of the scenario database helps to evaluate whether the target person promotes a talk along this development.

Upon finishing the processes up to S300, the processor 31 generates and outputs evaluation data describing the evaluation results obtained heretofore. The processor 31 can associate the evaluation data with the corresponding user ID and store the data in the storage 33.

Specifically, the processor 31 can generate the evaluation data describing the first score based on the target person's voice, the second score based on the non-target person's voice, the third score related to the voice distribution, and the fourth score related to the flow of explanation.

The evaluation data may include the parameters used in the evaluations, such as the conversational ball roiling rate and the key word group extracted from each utterance section. The evaluation data stored in the storage 33 is transmitted from the server device 30 to the management device 50 in response to access from the management device 50.

According to the evaluation system 1 of the present embodiment, the speech act of the target person during the business talk can be appropriately evaluated. This evaluation result is useful for improving the target person's skill in business talks.

In the present embodiment, in particular, it s possible to perform a speaker separation suitable for the evaluation from the recorded mixed speech without registering the business partner's voice (S230). The processor 31 separates the input voice signal acquired from the microphone 15 and contained in the voice data 132 into a voice component of the target person who is registered and a voice component of the non-target person other than the registered person based on the voice feature data related to the feature of the voice of the registered target person.

Moreover, in the present embodiment, the business talk act of the target person is evaluated not only from the contents of utterance of the target person, but also based on the contents of utterance of the business partner who is the non-target person in S270.

The contents of utterance of the business partner varies depending on the presence and absence of interest in the products and/or services that the target person explains. In addition, depending on the personality and knowledge of the business partner, the business partner reacts variously to the explanation made by the target person. Thus, it is very advantageous to evaluate the business talk act of the target person based on the business partner's contents of utterance.

Moreover, in the present embodiment, the business talk act of the target person is evaluated by use of evaluation models and/or key words different for each topic in the evaluations in S260 and S270. Such evaluations contribute to improve the evaluation accuracy.

As in the case of the present embodiment, it is also advantageous to determine the topic by use of the digital material displayed to the business partner when the target person explains the products and/or services. The contents to be orally explained together with the digital material and the topic corresponding to the digital material are usually definite. Thus, it is very advantageous for an appropriate evaluation to determine the topic based on the digital material and to evaluate the speech act of the target person using the corresponding evaluation model.

In the present embodiment, the feature amount related to the feelings, in particular, at least one of the speaking speed, the voice volume, and the pitch is calculated from the non-target person's voice (S640), and these are used for the evaluation of the business talk act of the target person. Consideration of the non-target person's feelings is useful for the appropriate evaluation of the business talk act. In a good conversation, the target person and the non-target person alternately speak in a proper rhythm. Thus, it is also advantageous to use the conversational ball rolling rate for the evaluation in S290.

It should be appreciated that the technique of the present disclosure is not limited to the aforementioned embodiment, and may adopt various modes. For example, a method of evaluating the business talk act of the target person should not be limited to the aforementioned embodiment.

For example, in S260, the first score for each topic may be calculated by a simple evaluation method in which the first score is calculated based on the number or frequency of the key words uttered by the target person. The first score itself may be the number or the frequency of the key words uttered.

Also in S270, by a similar method the second score may be calculated based on the number or frequency of the affirmative key words uttered by the non-target person. The second score itself may be the number or the frequency of the affirmative key words uttered.

In S270, the second score may be calculated by use of a machine learned evaluation model instead of using, the key words. The evaluation model to calculate the second score may be prepared separately from the evaluation model to calculate the first score. The processor 31 can calculate the second score by inputting a feature vector into the evaluation model, the feature vector generated by morphologically analyzing the non-target person's voice in the evaluation target section.

The evaluation models may be generated by machine learning; however, the evaluation models are not necessarily generated by machine learning. For example, the evaluation model may be a classifier generated by machine learning, and may be a simple score calculation formula defined by a designer.

The evaluation model to calculate the first score and the evaluation model to calculate the second score are not necessarily provided for each topic. That is, an evaluation model common to multiple topics may be used.

Without determining the topic in S240, the score calculation and the topic determination may be performed concurrently for each target person section G2 by use of an evaluation model in S260. In this case, the evaluation model may be configured to output, for each topic, the probability that the contents of utterance corresponding to the inputted feature vector is the contents of utterance related to the corresponding topic.

In this case, the processor 31 can determine that a topic having the highest probability is the topic of the corresponding section. Furthermore, the processor 31 can use the above-described probability of the determined topic itself as the first score. The evaluation model may be configured to output a higher probability as the contents of utterance of the target person is closer to the exemplary talk script.

In addition, the processor 31 may correct the first score depending on whether the digital material is displayed, in a case where no digital material is displayed, the first score may be reduced. The processor 31 may evaluate the business talk act of the target person based on difference in speaking speed between the target person and the non-target person. If the difference is smaller, the processor 31 may highly evaluate the business talk act of the target person.

It should be appreciated that methods of recording and transmitting the voices and the display history are not limited to the aforementioned embodiment. For example, it is not necessary to concurrently perform the recordings of the voices and the display history. For example, the evaluation system 1 may be configured to record the voices based on an instruction from the target person to record the voices, and to record the display history based on an instruction from the target person to record the display history. In this case, the voices and the display each can be recorded with timecode on the same time axis.

The function of one component in the above-described embodiments may be distributed and provided to a plurality of components. Functions of a plurality of components may be integrated into one component. A part of the configuration of the above embodiments may be omitted. At least a part of the configuration in one of the above embodiments may be added or replaced with the configuration of another one of the above embodiments. Any embodiments included in the technical idea specified from the language of the claims correspond to the embodiments of the present disclosure.

1. An evaluation system comprising:
an acquisition part configured to acquire an input voice signal from a microphone collecting voices in a business talk between a first speaker and a second speaker;
a separating part configured to separate a first voice component corresponding to a voice of the first speaker and a second voice component corresponding to a voice of the second speaker in the input voice signal; and
an evaluating part configured to evaluate a speech act of the first speaker based on at least one of the first voice component and the second voice component separated.

2. The evaluation system according to claim 1, further comprising a storage part configured to store voice feature data representing a feature of a voice of a registered person,
wherein the first speaker is the registered person,
wherein the second speaker is a speaker other than the registered person, and
wherein the separating part separates the first voice component and the second voice component in the input voice signal based on the voice feature data.

3. The evaluation system according to claim 1,
wherein the evaluating part evaluates the speech act of the first speaker based on the second voice component.

4. The evaluation system according to claim 1,
wherein the evaluating part evaluates the speech act of the first speaker based on a key word uttered from the second speaker and contained in the second voice component.

5. The evaluation system according to claim 1,
wherein the evaluating part extracts a key word from the second voice component, the key word uttered from the second speaker and corresponding to a topic between the first speaker and the second speaker, and
wherein the evaluating part evaluates the speech act of the first speaker based on the key word extracted.

6. The evaluation system according to claim 5,
wherein the evaluating part determines the topic based on the first voice component.

7. The evaluation system according claim 1,
wherein the evaluating part acquires identification information of a digital material displayed through a digital device from the first speaker to the second speaker,
wherein, based on the identification information, the evaluating part extracts a key word from the second voice component, the key word uttered from the second speaker and corresponding to the digital material, and
wherein, based on the key word extracted, the evaluating part evaluates the speech act of the first speaker.

8. The evaluation system according to claim 1,
wherein, based on the second voice component, the evaluating part determines at least one of a speaking speed, a voice volume, and a pitch of the second speaker, and based on the at least one of the speaking speed, the voice volume, and the pitch of the second speaker, the evaluating part evaluates the speech act of the first speaker.

9. The evaluation system according to claim 1,
wherein the evaluating part evaluates the speech act of the first speaker based on the first voice component.

10. The evaluation system according to claim 9,
wherein the evaluating part evaluates the speech act of the first speaker based on an evaluation model among multiple evaluation models, the evaluation model corresponding to a topic between the first speaker and the second speaker.

11. The evaluation system according to claim 9,
wherein the evaluating part inputs feature data into an evaluation model among multiple evaluation models calculating scores related to a speech act, the feature data related to the speech act of the first speaker based on the first voice component, the evaluation model corresponding a topic between the first speaker and the second speaker, and
wherein the evaluating part evaluates the speech act of the first speaker based on a score outputted from the evaluation model corresponding to the topic in response to the feature data inputted.

12. The evaluation system according to claim 9,
wherein the evaluating part
acquires identification information of a digital material displayed through a digital device from the first speaker to the second speaker,
selects an evaluation model as a material-corresponding model among multiple evaluation models based on the identification information, the evaluation model corresponding to the digital material, the multiple evaluation models calculating scores related to a speech act,
inputs feature data into the material-corresponding model, the feature data related to the speech act of the first speaker based on the first voice component, and
evaluates the speech act of the first speaker based on a score outputted from the material-corresponding model in response to the feature data inputted.

13. The evaluation system according to claim 10,
wherein each of the multiple evaluation models is built by machine learning using, as teacher data, feature data related to an exemplary speech act of a corresponding topic.

14. The evaluation system according to claim 1,
wherein the evaluating part further determines distribution of utterance of the first speaker and the second speaker based on the input voice signal, and
wherein, based on the distribution, the evaluating part evaluates the speech act of the first speaker.

15. The evaluation system according to claim 14,
wherein, as the distribution, the evaluating part determines at least one of a ratio of utterance time between the first speaker and the second speaker and a ratio of an amount of utterance between the first speaker and the second speaker.

16. The evaluation system according to claim 1,
wherein the evaluating part
estimates a problem that the second speaker has based on the second voice component,
determines whether the first speaker provides the second speaker with information corresponding to the problem based on the first voice component, and
evaluates the speech act of the first speaker based on determination whether the information is provided.

17. The evaluation system according to claim 1,
wherein, based on the first voice component and the second voice component, the evaluating part determines whether the first speaker develops a talk for the second speaker in accordance with a predetermined scenario, the talk corresponding to a reaction of the second speaker, and
wherein the evaluating part evaluates the speech act of the first speaker based on determination whether the talk is developed.

18. A computer-implemented evaluation method comprising:
acquiring an input voice signal from a microphone collecting voices in a business talk between a first speaker and a second speaker;
separating a first voice component representing a voice of the first speaker and a second voice component representing a voice of the second speaker in the input voice signal; and
evaluating a speech act of the first speaker based on at least one of the first voice component and the second voice component separated.

19. A computer readable non-transitory tangible storage medium storing a computer program including instructions to make a computer perform the evaluation method of claim 18.

20. The evaluation method according to claim 18,
wherein the evaluating includes:
inputting feature data into an evaluation model among multiple evaluation models calculating scores related to a speech act, the feature data related to the speech act of the first speaker based on the first voice component, the evaluation model corresponding a topic between the first speaker and the second speaker; and
evaluating the speech act of the first speaker based on a score outputted from the evaluation model corresponding to the topic in response to the feature data inputted, and
wherein each of the multiple evaluation models is built by machine learning using, as teacher data, feature data related to an exemplary speech act of a corresponding topic.
